(19) United States
(12) Patent Application Publication
(10) Pub. No.: US 2007/0126547 A1
(43) Pub. Date: Jun. 7, 2007

(54) One-piece fuse insert, method for producing the one-piece fuse insert, and device for implementing the method

(76) Inventors: Henning Schulte, Wildeshausen (DE); Jurgen Scheele, Wildeshausen (DE)

Correspondence Address: WILLIAM COLLARD;COLLARD & ROE, P.C., 1077 NORTHERN BOULEVARD, ROSLYN, NY, 11576, US

(21) Appl. No.: 10/582,729

(22) PCT Filed: Dec. 13, 2004
(86) PCT No.: PCT/DE04/02728

§ 371 Date: Aug. 16, 2006

(30) Foreign Application Priority Data
Dec. 13, 2003 (DE) 103 58 444.7

(51) Int. Cl. H01H 85/04

(52) U.S. Cl. 337/159

(57) ABSTRACT

The invention relates to a one-piece fuse insert made from a stamped flat piece of sheet, in particular of a zinc sheet, the contacts of which are connected by a connector piece, forming a fusing conductor, whereby at least a part of the connector piece is flattened such that the thickness thereof is reduced by a certain amount, relative to the original thickness of the sheet. According to the invention, the one-piece fuse insert is produced from a strip of sheet, in particular, zinc sheet, transported longitudinally through machining tools, by means of which the contour of the fuse insert is produced from the strip, which comprises contacts and a connector piece, connecting said contacts. The connector piece is then thinned by stamping with a given force.

The invention relates to a one-piece fuse insert consisting of a flat part punched from sheet metal, particularly zinc sheet metal, particularly a flat plug, the contacts of which are connected with one another by means of a connection piece that forms a fusible conductor. The invention also relates to a method for producing a one-piece fuse insert, in which a strip of sheet metal, particularly zinc sheet metal, is transported lengthwise through machining tools, with which the contours of the fuse insert are worked out of the strip, which fuse insert consists of contacts and a connection piece that connects the contacts. Furthermore, the invention also relates to a device for implementing the method.

One-piece fuse inserts are known. The fuse inserts are flat parts punched from sheet metal, particularly flat plugs, the plug contacts of which are connected with one another by means of a connection piece that forms a fusible conductor.

The sheet metal from which the fuse inserts are produced consequently consists of a material that is suitable for use as a fusible conductor in fuses. It is known to produce one-piece fuse inserts from zinc sheet metal. Often, the zinc sheet metal is provided with coatings that protect against corrosion, or also with coatings that improve an electrical connection of the fuse inserts with the bushings of the securing holder. Protective tin or silver coatings are known.

One-piece fuse inserts are produced in different rated current strengths, while keeping the same design. The value of the rated current strength is dependent on the cross-section of the connection piece that serves as a fusible conductor. The greatest rated current strength is achieved if the connection piece has the full thickness of the sheet metal, without being changed, in other words only the contour of the connection piece is cut out of the sheet metal being used. Thinner zinc sheet metal would reduce the value of the rated current strength, but has the disadvantage, in this connection, that thinner sheet metal often can no longer fulfill the requirements that are set for the contacts.

In the production of one-piece fuse inserts, the method of procedure is therefore such that in order to achieve a certain rated current strength, the sheet metal being used is reduced to a predetermined value in its thickness, in the continuous surface region from which the connection piece is supposed to be made, by means of machining that removes material, e.g. milling, in such a manner that connection pieces can be cut from the sheet metal region that remains between the contacts of the flat plug, which pieces guarantee the desired value of the rated current strength of the fuse inserts being produced, in each instance.

However, the machining that removes material, milling, has the disadvantage that the coating that protects against corrosion is worn off the sheet metal. It is also disadvantageous that the particular work process of milling must be carried out before the strip of sheet metal passes through the machining tool, in order to form the fuse inserts.

The invention is based on the task of being able to make available a one-piece fuse insert in which the advantageous corrosion protection in the form of tin or silver coatings is maintained, although the cross-section of the connection piece to achieve predetermined rated current strengths is reduced as compared with the thickness of the sheet metal used for production.

This task is accomplished, according to the invention, by means of the characteristics of claim 1. In terms of method, the task is accomplished by means of the characteristics of claim 2, for which independent protection is being sought. Advantageous embodiments and further developments of the solution of the task in terms of method are evident from claims 3 and 4.

For implementing the method according to one of claims 2 to 4, a device is provided, for which independent protection is also claimed, in accordance with claim 5.

The one-piece fuse insert consists of a flat part punched from sheet metal, particularly zinc sheet metal, particularly a flat plug, the plug contacts of which are connected with one another by means of a connection piece that forms a fusible conductor and is left behind when the contours are formed. Such a fuse insert is characterized in that at least one segment of the connection piece is pressed flat in such a manner that its thickness is reduced by a predetermined dimension as compared with the original thickness of the sheet metal. Depending on the selection of the predetermined dimension of the reduction in thickness, the fuse insert is thereby given a predetermined rated current strength. However, pressing it flat has the advantage, as compared with the known milling, that the cross-section of the connection piece becomes less without removing protective coatings made of tin or silver. In the case of the fuse insert according to the invention, the connection piece that forms the fusible conductor still has the protective coating even after it has been pressed flat for the purpose of achieving a certain rated current strength.

The one-piece fuse insert is produced, according to the invention, in such a manner that a strip of sheet metal, particularly zinc sheet metal, is transported lengthwise through machining tools, preferably step by step, with which tools the contours of the fuse insert are worked out of the strip, which fuse insert consists of contacts and a connection piece that remains and connects the contacts. This connection piece is stamped and made thin, according to the invention, to a predetermined thickness. Machining that removes material is eliminated, so that the corrosion-protecting coatings of the strip of sheet metal are retained, specifically in the region of the connection piece.

The machining process of machining of the strip of sheet metal that removes material is eliminated. In the case of the method of procedure for producing one-piece fuse inserts that was known until now, the machining that removes material had to be carried out on the strip of sheet metal before it is introduced into the machining tools. In the case of the method according to the invention, the strip of sheet metal can be transported into the machining tools without delay, without prior machining, because the machining tools are tools that perform punch strokes, which can easily be used also for carrying out stamping, with particular advantage.

In the case of the method, at least a certain partial segment of the connection piece is stamped and made thin, to a predetermined thickness.

However, it is also easily possible to stamp several specific segments of the connection piece and make them thin, or to make the entire contour of the connection piece thinner, by means of corresponding stamping pressure.

The method according to the invention also comprises the method step that the material excess of the connection piece that forms during stamping to make it thin is removed from the connection piece by means of cutting it away. This, too, can be carried out in the machining tools, with a corresponding cutting or punching station.

With particular advantage, a device for implementing the method is provided, which has punching and pressing tools oriented in a row, one after the other, in a machining unit, through which the strip being transported step by step is passed, and in which all of the machining of the sheet-metal strip takes place, in corresponding punch strokes.

The sheet-metal strip from which the fuse inserts are supposed to be produced runs into the machining unit, whereby the advance is controlled step by step. Accordingly, the sheet-metal strip is machined in the machining unit by means of a punch stroke, after every advancing step, with the punching and pressing tools that are assigned in accordance with the advancing position, and predetermined, in each instance. Thus, for example, the contour is cut out with first punching tools, in the feed direction, and the connection piece is stamped thin in a subsequent pressing tool. A cutting tool can be integrated into the pressing or stamping tool, which handles cutting the excess material away towards the end of the machining stroke to be carried out. Of course, it is also possible to dispose a cutting tool that follows the pressing tool in the pass-through direction in the machining unit. Once the sheet-metal strip has passed through the machining unit in a predetermined number of machining steps, the finished one-piece fuse inserts, at the desired rated current strength, in each instance, are present at the output side of the machining unit.

An exemplary embodiment of the invention, from which other inventive characteristics are evident, is shown in the drawing. This shows:

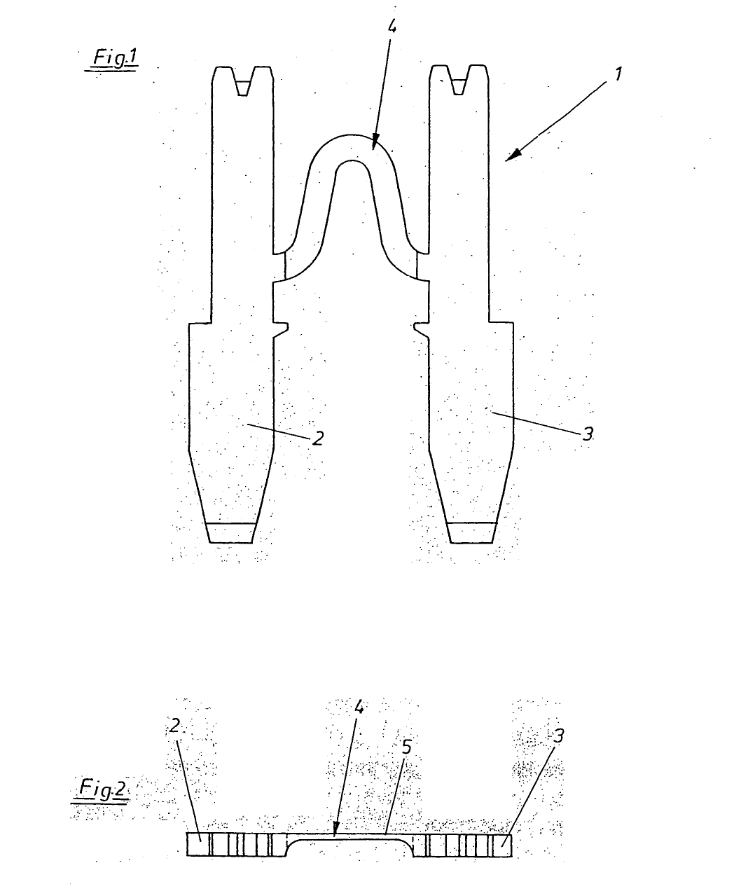

FIG. 1 a side view of a one-piece fuse insert, in approximately 10× magnification, and

FIG. 2 a view of the fuse insert according to FIG. 1 from above.

FIG. 1 shows a one-piece fuse insert 1, which is configured as a punched flat part made from a sheet metal, preferably zinc sheet metal. FIG. 1 illustrates the contours of the fuse insert 1, which consists of contacts 2 and 3 as well as a connection piece 4 that remains and connects the contacts 2 and 3. The center segment 5 of the connection piece is pressed thin to a predetermined thickness, specifically by means of stamping, in such a manner that its thickness is reduced by a predetermined dimension, as compared with the original thickness of the sheet metal for the fuse insert 1.

This configuration is particularly illustrated in FIG. 2, which shows the fuse insert according to FIG. 1 in a view from above. The same components are designated with the same reference numbers.

FIG. 2 particularly illustrates that the contacts 2 and 3 still have the original sheet-metal thickness, while the connection piece 4 has been stamped thin to a thickness of 0.2 mm, for example, so that the one-piece fuse insert that is shown has a predetermined rated current strength.

The material excess that occurs during stamping is removed from the connection piece 4 by cutting it away, and this takes place, in simplest manner, in a punching process.

1. One-piece fuse insert consisting of a flat part punched from sheet metal, particularly zinc sheet metal, particularly a flat plug, the contacts of which are connected with one another by means of a connection piece that forms a fusible conductor,
wherein
at least one segment (5) of the connection piece (4) is pressed flat in such a manner that its thickness is reduced by a predetermined dimension as compared with the original thickness of the sheet metal.

2. Method for producing a one-piece fuse insert, particularly a fuse insert according to claim 1, in which a strip of sheet metal, particularly zinc sheet metal, is transported lengthwise through machining tools, with which the contours of the fuse insert are worked out of the strip, which fuse insert consists of contacts and a connection piece that connects the contacts,
wherein
the connection piece (4) is stamped and made thin, to a predetermined thickness.

3. Method according to claim 2, wherein at least a certain partial segment (5) of the connection piece (4) is stamped and made thin, to a predetermined thickness.

4. Method according to claim 2, wherein the material excess of the connection piece that forms during stamping to make it thin is removed from the connection piece (4) by means of cutting it away.

5. Device for implementing the method according to claim 2, comprising
punching and pressing tools oriented in a row, one after the other, in a machining unit, through which the strip being transported step by step is passed, and in which all of the machining of the sheet-metal strip can be carried out in a punch stroke.
